(19) United States
(12) Patent Application Publication
(10) Pub. No.: US 2013/0010659 A1
(43) Pub. Date: Jan. 10, 2013

(54) SOUNDING REFERENCE SIGNALS IN ASYMMETRIC CARRIER AGGREGATION

(75) Inventors: Wanshi Chen, San Diego, CA (US); Juan Montojo, San Diego, CA (US); Peter Gaal, San Diego, CA (US)

(73) Assignee: QUALCOMM Incorporated, San Diego, CA (US)

(21) Appl. No.: 13/532,400

(22) Filed: Jun. 25, 2012

Related U.S. Application Data
(60) Provisional application No. 61/505,621, filed on Jul. 8, 2011.

(51) Int. Cl. H04W 72/04; H04L 5/14; H04W 4/00

(52) U.S. Cl. 370/280; 370/328; 370/329

(57) ABSTRACT

Sounding reference signal (SRS) transmission is disclosed for asymmetric carrier aggregation, where the carrier aggregation occurs using multiple component carriers that include both paired and at least one non-paired component carrier. A user equipment (UE) determines whether to transmit SRS over at least one of the non-paired component carriers. The UE transmits the SRS over the non-paired component carrier when the determination is made. The UE maintains a single component carrier transmission at a time with a single carrier waveform SRS transmission by transmitting the SRS on a different component carrier at different subframes.

### CROSS-REFERENCE TO RELATED APPLICATIONS

This application claims the benefit of U.S. Provisional Patent Application No. 61/505,621, entitled, “SOUNDING REFERENCE SIGNALS IN ASYMMETRIC CARRIER AGGREGATION”, filed on Jul. 8, 2011, which is expressly incorporated by reference herein in its entirety.

### BACKGROUND

1. Field

Aspects of the present disclosure relate generally to wireless communication systems, and more particularly, to sounding reference signals (SRS) in asymmetric carrier aggregation.

2. Background

Wireless communication networks are widely deployed to provide various communication services such as voice, video, packet data, messaging, broadcast, etc. These wireless networks may be multiple-access networks capable of supporting multiple users by sharing the available network resources. Examples of such multiple-access networks include Code Division Multiple Access (CDMA) networks, Time Division Multiple Access (TDMA) networks, Frequency Division Multiple Access (FDMA) networks, Orthogonal FDMA (OFDMA) networks, and Single-Carrier FDMA (SC-FDMA) networks.

A wireless communication network may include a number of base base stations that can support communication for a number of user equipments (UEs). A UE may communicate with a base station via the downlink and uplink. The downlink (or forward link) refers to the communication link from the base station to the UE, and the uplink (or reverse link) refers to the communication link from the UE to the base station. This communication link may be established via a single-in-single-out (SIMO), multiple-in-single-out, or a multiple-in-multiple-out (MIMO) system.

A MIMO system employs multiple (N_{T}) transmit antennas and multiple (N_{R}) receive antennas for data transmission. A MIMO channel formed by the N_{T} transmit and N_{R} receive antennas may be decomposed into N_{S} independent channels, which are also referred to as spatial channels, where N_{S}≦min {N_{T}, N_{R}}. Each of the N_{S} independent channels corresponds to a dimension. The MIMO system can provide improved performance (e.g., higher throughput and/or greater reliability) if the additional dimensionalities created by the multiple transmit and receive antennas are utilized.

In addition, terminals can transmit SRS to base stations, which can be utilized, for example, to determine the uplink channel quality. Base stations can utilize the SRSs in allocating uplink resources to the transmitting terminal. SRS may be used for a variety of actions, such as uplink link adaptation, downlink scheduling under channel reciprocity (especially for time division duplex (TDD) systems, coordinated multipoint (COMP) operation, and the like. In LTE Release 8 (Rel 8), certain parameters for transmitting SRSs, such as a maximum transmission bandwidth, available subframes, etc., related to a specific cell, can be defined during operation of a wireless network. Furthermore, terminal specific parameters, such as a configuration index of the SRS period and subframe offset for a particular mobile terminal, bandwidth for the terminal, transmission comb, SRS transmission duration, cyclic shift for generating the reference sequence, and/or the like, can also be defined at runtime. Terminals in Rel-8 can transmit SRSs as specified by these parameters. LTE-Advanced (LTE-A) terminals can support more advanced technologies and features that can benefit from enhancements to SRS configuration.

### SUMMARY

Techniques for sounding reference signal (SRS) transmission in asymmetric carrier aggregation are described herein. In asymmetric carrier aggregation, the carrier aggregation occurs using multiple component carriers that include both paired and non-paired component carriers. The user equipment (UE) determines whether to transmit SRS over at least one of the non-paired components and transmits the SRS over the non-paired component carriers according to the determination. The UE maintains a single component carrier transmission at a time with a single carrier waveform SRS transmission by transmitting the SRS on a different component carrier at different subframes.

In an aspect, a method for wireless communication includes determining whether to transmit SRS over at least one non-paired component carrier within multiple component carriers. The multiple component carriers include both paired and non-paired component carriers. The method also includes transmitting the SRS over the non-paired component carrier based on the determination.

In another aspect, an apparatus for wireless communication includes means for determining whether to transmit SRS over at least one non-paired component carrier within multiple component carriers. The multiple component carriers include both paired and non-paired component carriers. The apparatus also includes means for transmitting the SRS over the non-paired component carrier based on the determination.

In another aspect, a computer program product includes a computer-readable storage medium having program code stored thereon. The program code includes code for determining whether to transmit SRS over at least one non-paired component carrier within multiple component carriers. The multiple component carriers include both paired and non-paired component carriers. The computer program product also includes code for transmitting the SRS over the non-paired component carrier based on the determination.

In another aspect, a UE configured for wireless communication includes at least one processor and a memory coupled to the processor. The processor is configured to determine whether to transmit SRS over at least one non-paired component carrier within multiple component carriers. The multiple component carriers include both paired and non-paired component carriers. The processor is also configured to transmit the SRS over the non-paired component carrier based on the determination.

Various aspects and features of the disclosure are described in further detail below. To the accomplishment of the foregoing and related ends, one or more aspects comprise the features hereinafter fully described and particularly pointed out in the claims. The following description and annexed drawings set forth in detail certain illustrative aspects and are indicative of but a few of the various ways in which the principles of the aspects may be employed. Other advantages and novel features will become apparent from the following detailed description when considered in conjunction with the drawings and the disclosed aspects are intended to include all such aspects and their equivalents.

### BRIEF DESCRIPTION OF THE DRAWINGS

FIG. 1 is a block diagram conceptually illustrating an example of a telecommunications system;

FIG. 2 is a block diagram conceptually illustrating an example of a down link frame structure in a telecommunications system;

FIG. 3 is a block diagram conceptually illustrating a design of a base station/eNodeB and a UE configured according to one aspect of the present disclosure;

FIG. 4A discloses a continuous carrier aggregation type;

FIG. 4B discloses a non-continuous carrier aggregation type;

FIG. 5 discloses MAC layer data aggregation; and

FIG. 6 is a block diagram illustrating a method for controlling radio links in multiple carrier configurations.

FIG. 7 is a block diagram illustrating a carrier aggregation configured asymmetrically in a frequency division duplex (FDD) implementation.

FIG. 8 is a block diagram illustrating a carrier aggregation configured asymmetrically in a time division duplex (TDD) implementation.

FIG. 9A is a block diagram illustrating a carrier aggregation with SRS signaling configured according to one aspect of the present disclosure.

FIG. 9B is a block diagram illustrating a carrier aggregation with SRS signaling configured according to one aspect of the present disclosure.

FIG. 10 is a block diagram illustrating one TDD subframe of a carrier aggregation with SRS transmissions configured according to one aspect of the present disclosure.

FIG. 11 is a functional block diagram illustrating example blocks executed to implement one aspect of the present disclosure.

FIG. 12 is a functional block diagram illustrating example blocks executed by a UE to implement one aspect of the present disclosure.

FIG. 13 is a block diagram illustrating a UE configured according to one aspect of the present disclosure.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

The techniques described herein may be used for various wireless communication networks such as CDMA, TDMA, FDMA, OFDMA, SC-FDMA and other networks. The terms “network” and “system” are often used interchangeably. A CDMA network may implement a radio technology such as Universal Terrestrial Radio Access (UTRA), cdma2000, etc. UTRA includes Wideband CDMA (WCDMA) and other variants of CDMA. cdma2000 covers IS-2000, IS-95 and IS-856 standards. A TDMA network may implement a radio technology such as Global System for Mobile Communications (GSM). An OFDMA network may implement a radio technology such as Evolved UTRA (E-UTRA), Ultra Mobile Broadband (UMB), IEEE 802.11 (Wi-Fi), IEEE 802.16 (WiMAX), IEEE 802.20, Flash-OFDMA, etc. UTRA and E-UTRA are part of Universal Mobile Telecommunication System (UMTS). 3GPP Long Term Evolution (LTE) and LTE-Advanced (LTE-A) are new releases of UMTS that use E-UTRA. UTRA, E-UTRA, UMTS, LTE, LTE-A and GSM are described in documents from an organization named “3rd Generation Partnership Project” (3GPP). cdma2000 and UMB are described in documents from an organization named “3rd Generation Partnership Project 2” (3GPP2). The techniques described herein may be used for the wireless networks and radio technologies mentioned above as well as other wireless networks and radio technologies. For clarity, certain aspects of the techniques are described below for LTE, and LTE terminology is used in much of the description below.

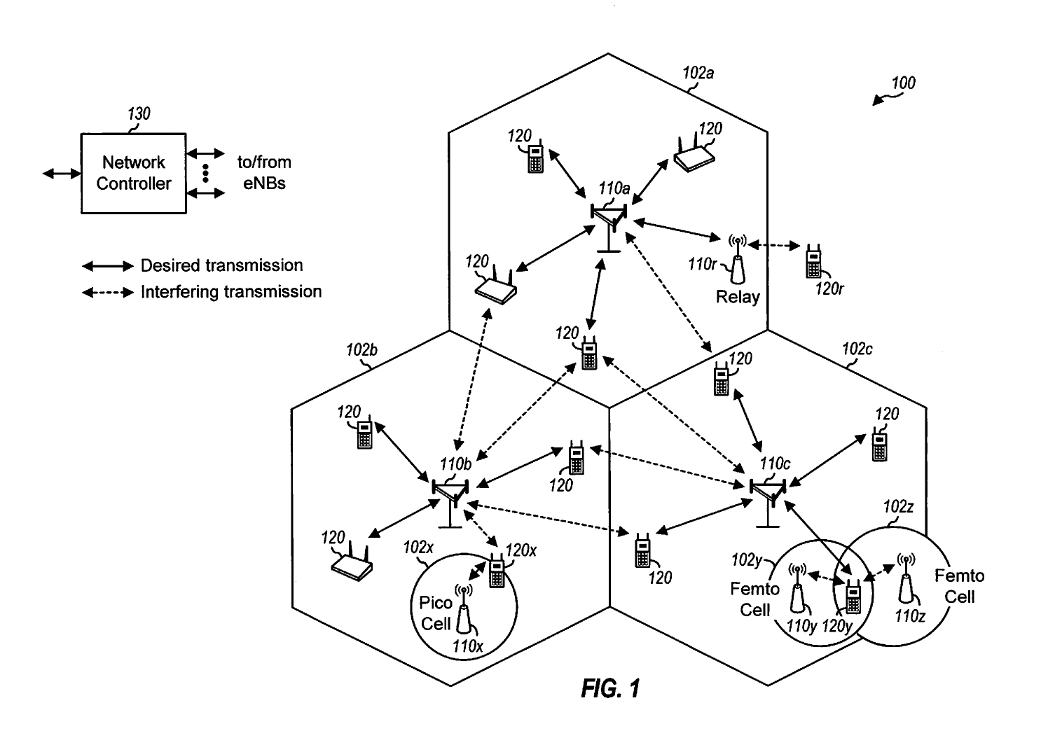

FIG. 1 shows a wireless communication network 100, which may be an LTE network. The wireless network 100 may include a number of evolved Node Bs (eNodeBs) 110 and other network entities. An eNodeB may be a station that communicates with the UEs and may also be referred to as a base station, an access point, etc. A Node B is another example of a station that communicates with the UEs.

Each eNodeB 110 may provide communication coverage for a particular geographic area. In 3GPP, the term “cell” can refer to a coverage area of an eNodeB and/or an eNodeB subsystem serving this coverage area, depending on the context in which the term is used.

An eNodeB may provide communication coverage for a macro cell, a pico cell, a femto cell, and/or other types of cell. A macro cell may cover a relatively large geographic area (e.g., several kilometers in radius) and may allow unrestricted access by UEs with service subscription. A pico cell may cover a relatively small geographic area and may allow unrestricted access by UEs with service subscription. A femto cell may cover a relatively small geographic area (e.g., a home) and may allow restricted access by UEs having association with the femto cell (e.g., UEs in a Closed Subscriber Group (CSG), UEs for users in the home, etc.). An eNodeB for a macro cell may be referred to as a macro eNodeB. An eNodeB for a pico cell may be referred to as a pico eNodeB. An eNodeB for a femto cell may be referred to as a femto eNodeB or a home eNodeB. In the example shown in FIG. 1, the eNodeBs 110a, 110b and 110c may be macro eNodeBs for the macro cells 102a, 102b and 102c, respectively. The eNodeB 110x may be a pico eNodeB for a pico cell 102x. The eNodeBs 110y and 110z may be femto eNodeBs for the femto cells 102y and 102z, respectively. An eNodeB may support one or multiple (e.g., three) cells.

The wireless network 100 may also include relay stations. A relay station is a station that receives a transmission of data and/or other information from an upstream station (e.g., an eNodeB or a UE) and sends a transmission of the data and/or other information to a downstream station (e.g., a UE or an eNodeB). A relay station may also be a UE that relays transmissions for other UEs. In the example shown in FIG. 1, a relay station 110r may communicate with the eNodeB 110a and a UE 120r in order to facilitate communication between the eNodeB 110a and the UE 120r. A relay station may also be referred to as a relay eNodeB, a relay, etc.

The wireless network 100 may be a heterogeneous network that includes eNodeBs of different types, e.g., macro eNodeBs, pico eNodeBs, femto eNodeBs, relays, etc. These different types of eNodeBs may have different transmit power levels, different coverage areas, and different impact on interference in the wireless network 100. For example, macro eNodeBs may have a high transmit power level (e.g., 20 Watts) whereas pico eNodeBs, femto eNodeBs and relays may have a lower transmit power level (e.g., 1 Watt).

The wireless network 100 may support synchronous or asynchronous operation. For synchronous operation, the eNodeBs may have similar frame timing, and transmissions from different eNodeBs may be approximately aligned in time. For asynchronous operation, the eNodeBs may have different frame timing, and transmissions from different eNodeBs may not be aligned in time. The techniques described herein may be used for both synchronous and asynchronous operation.

A network controller 130 may couple to a set of eNodeBs and provide coordination and control for these eNodeBs. The network controller 130 may communicate with the eNodeBs 110 via a backhaul. The eNodeBs 110 may also communicate with one another, e.g., directly or indirectly via wireless or wireline backhaul.

The UEs 120 may be dispersed throughout the wireless network 100, and each UE may be stationary or mobile. A UE may also be referred to as a terminal, a mobile station, a subscriber unit, a station, etc. A UE may be a cellular phone, a personal digital assistant (PDA), a wireless modem, a wireless communication device, a handheld device, a laptop computer, a cordless phone, a wireless local loop (WLL) station, etc. A UE may be able to communicate with macro eNodeBs, pico eNodeBs, femto eNodeBs, relays, etc. In FIG. 1, a solid line with double arrows indicates desired transmissions between a UE and a serving eNodeB, which is an eNodeB designated to serve the UE on the downlink and/or uplink. A dashed line with double arrows indicates interfering transmissions between a UE and an eNodeB.

LTE/-A utilizes orthogonal frequency division multiplexing (OFDM) on the downlink and single-carrier frequency division multiplexing (SC-FDM) on the uplink. OFDM and SC-FDM partition the system bandwidth into multiple (K) orthogonal subcarriers, which are also commonly referred to as tones, bins, or the like. Each subcarrier may be modulated with data. In general, modulation symbols are sent in the frequency domain with OFDM and in the time domain with SC-FDM. The spacing between adjacent subcarriers may be fixed, and the total number of subcarriers (K) may be dependent on the system bandwidth. For example, K may be equal to 72, 180, 300, 600, 900, and 1200 for a corresponding system bandwidth of 1.4, 3, 5, 10, 15, or 20 megahertz (MHz), respectively. The system bandwidth may also be partitioned into sub-bands. For example, a sub-band may cover 1.08 MHz, and there may be 1, 2, 4, 8 or 16 sub-bands for a corresponding system bandwidth of 1.4, 3, 5, 10, 15, or 20 MHz, respectively.

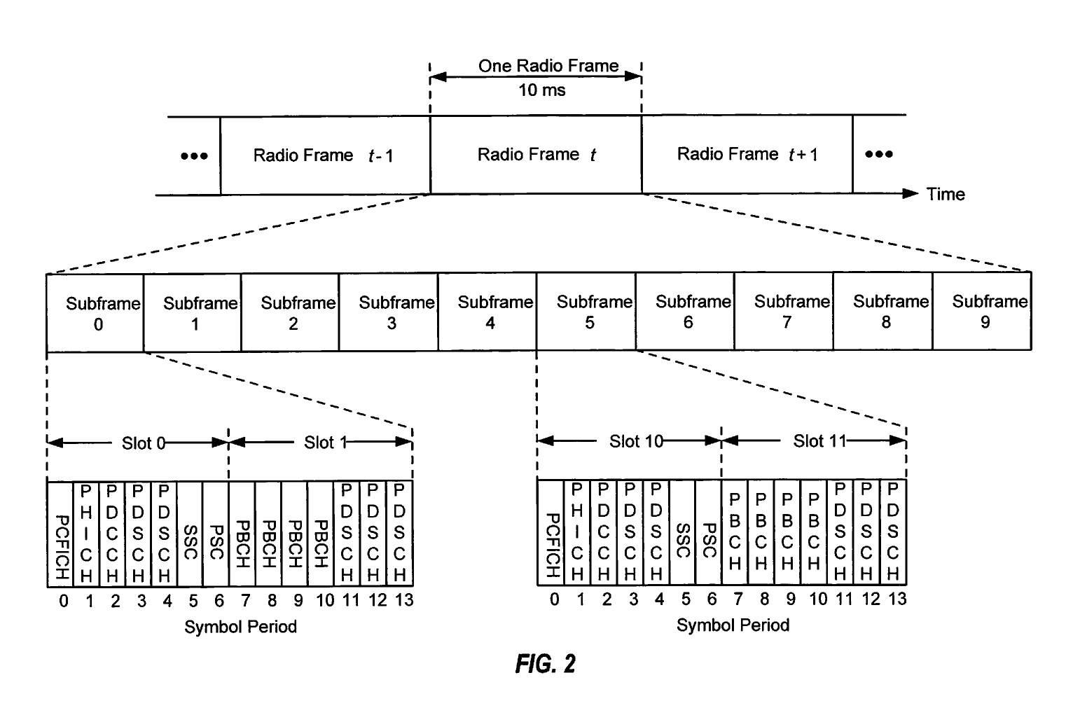

FIG. 2 shows a down link frame structure used in LTE. The transmission timeline for the downlink may be partitioned into units of radio frames. Each radio frame may have a predetermined duration (e.g., 10 milliseconds (ms)) and may be partitioned into 10 subframes with indices of 0 through 9. Each subframe may include two slots. Each radio frame may thus include 20 slots with indices of 0 through 19. Each slot may include L symbol periods, e.g., 7 symbol periods for a normal cyclic prefix (as shown in FIG. 2) or 14 symbol periods for an extended cyclic prefix. The 2L symbol periods in each subframe may be assigned indices of 0 through 2L-1. The available time frequency resources may be partitioned into resource blocks. Each resource block may cover N subcarriers (e.g., 12 subcarriers) in one slot.

In LTE, an eNodeB may send a primary synchronization signal (PSS) and a secondary synchronization signal (SSS) for each cell in the eNodeB. The primary and secondary synchronization signals may be sent in symbol periods 6 and 5, respectively, in each of subframes 0 and 5 of each radio frame with the normal cyclic prefix, as shown in FIG. 2. The synchronization signals may be used by UEs for cell detection and acquisition. The eNodeB may send a Physical Broadcast Channel (PBCH) in symbol periods 0 to 3 in slot 1 of subframe 0. The PBCH may carry certain system information.

The eNodeB may send a Physical Control Format Indicator Channel (PCFICH) in only a portion of the first symbol period of each subframe, although depicted in the entire first symbol period in FIG. 2. The PCFICH may convey the number of symbol periods (M) used for control channels, where M may be equal to 1, 2 or 3 and may change from subframe to subframe. M may also be equal to 4 for a small system bandwidth, e.g., with less than 10 resource blocks. In the example shown in FIG. 2, M=3. The eNodeB may send a Physical HARQ Indicator Channel (PHICH) and a Physical Downlink Control Channel (PDCCH) in the first M symbol periods of each subframe (M=3 in FIG. 2). The PHICH may carry information to support hybrid automatic retransmission (HARQ). The PDCCH may carry information on uplink and downlink resource allocation for UEs and power control information for uplink channels. Although not shown in the first symbol period in FIG. 2, it is understood that the PDCCH and PHICH are also included in the first symbol period. Similarly, the PHICH and PDCCH are also both in the second and third symbol periods, although not shown that way in FIG. 2. The eNodeB may send a Physical Downlink Shared Channel (PDSCH) in the remaining symbol periods of each subframe. The PDSCH may carry data for UEs scheduled for data transmission on the downlink. The various signals and channels in LTE are described in 3GPP TS 36.211, entitled “Evolved Universal Terrestrial Radio Access (E-UTRA); Physical Channels and Modulation,” which is publicly available.

The eNodeB may send the PSS, SSS and PBCH in the center 1.08 MHz of the system bandwidth used by the eNodeB. The eNodeB may send the PCFICH and PHICH across the entire system bandwidth in each symbol period in which these channels are sent. The eNodeB may send the PDCCH to groups of UEs in certain portions of the system bandwidth. The eNodeB may send the PDSCH to specific UEs in specific portions of the system bandwidth. The eNodeB may send the PSS, SSS, PBCH, PCFICH and PHICH in a broadcast manner to all UEs, may send the PDCCH in a unicast manner to specific UEs, and may also send the PDSCH in a unicast manner to specific UEs.

A number of resource elements may be available in each symbol period. Each resource element may cover one subcarrier in one symbol period and may be used to send one modulation symbol, which may be a real or complex value. Resource elements not used for a reference signal in each symbol period may be arranged into resource element groups (REGs). Each REG may include four resource elements in one symbol period. The PCFICH may occupy four REGs, which may be spaced approximately equally across frequency, in symbol period 0. The PHICH may occupy three REGs, which may be spread across frequency, in one or more configurable symbol periods. For example, the three REGs for the PHICH may all belong in symbol period 0 or may be spread in symbol periods 0, 1 and 2. The PDCCH may occupy 9, 18, 32 or 64 REGs, which may be selected from the available REGs, in the first M symbol periods. Only certain combinations of REGs may be allowed for the PDCCH.

A UE may know the specific REGs used for the PHICH and the PCFICH. The UE may search different combinations of REGs for the PDCCH. The number of combinations to search is typically less than the number of allowed combinations for the PDCCH. An eNodeB may send the PDCCH to the UE in any of the combinations that the UE will search.

A UE may be within the coverage of multiple eNodeBs. One of these eNodeBs may be selected to serve the UE. The serving eNodeB may be selected based on various criteria such as received power, path loss, signal-to-noise ratio (SNR), etc.

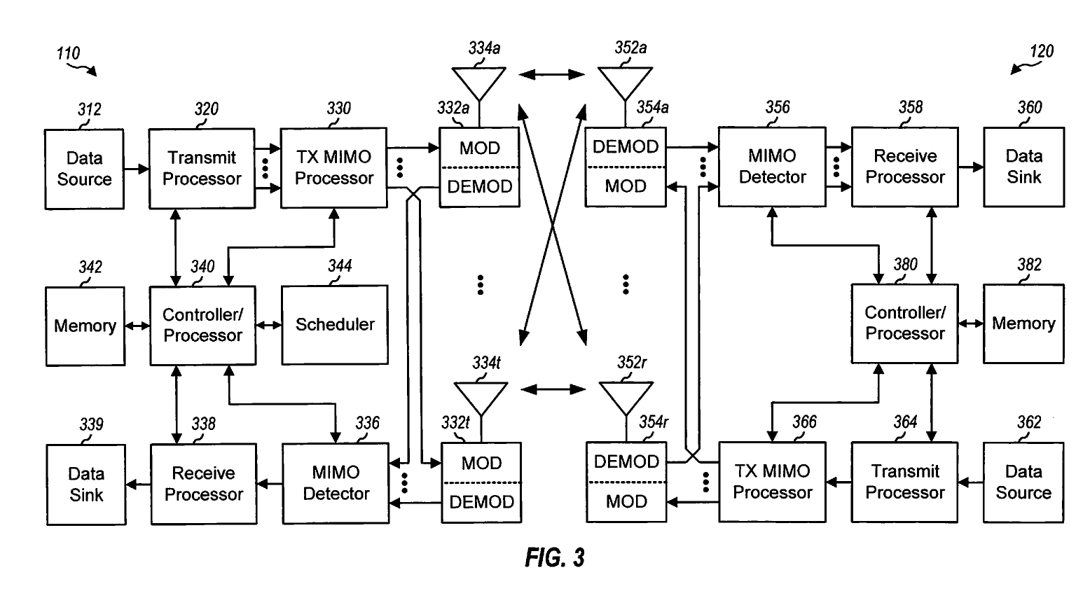

FIG. 3 shows a block diagram of a design of a base station/eNodeB 110 and a UE 120, which may be one of the base stations/eNodeBs and one of the UEs in FIG. 1. For a restricted association scenario, the base station 110 may be the macro eNodeB 110c in FIG. 1, and the UE 120 may be the UE 120y. The base station 110 may also be a base station of some other type. The base station 110 may be equipped with antennas 334a through 334t, and the UE 120 may be equipped with antennas 352a through 352r.

At the base station 110, a transmit processor 320 may receive data from a data source 312 and control information from a controller/processor 340. The control information may be for the PBCH, PCFICH, PHICH, PDCCH, etc. The data may be for the PDSCH, etc. The processor 320 may process (e.g., encode and symbol map) the data and control information to obtain data symbols and control symbols, respectively. The processor 320 may also generate reference symbols, e.g., for the PSS, SSS, and cell-specific reference signal. A transmit (TX) multiple-input multiple-output (MIMO) processor 330 may perform spatial processing (e.g., precoding) on the data symbols, the control symbols, and/or the reference symbols, if applicable, and may provide output symbol streams to the modulators (MODs) 332a through 332t. Each modulator 332 may process a respective output symbol stream (e.g., for OFDM, etc.) to obtain an output sample stream. Each modulator 332 may further process (e.g., convert to analog, amplify, filter, and upconvert) the output sample stream to obtain a downlink signal. Downlink signals from modulators 332a through 332t may be transmitted via the antennas 334a through 334t, respectively.

At the UE 120, the antennas 352a through 352r may receive the downlink signals from the base station 110 and may provide received signals to the demodulators (DEMODs) 354a through 354r, respectively. Each demodulator 354 may condition (e.g., filter, amplify, downconvert, and digitize) a respective received signal to obtain input samples. Each demodulator 354 may further process the input samples (e.g., for OFDM, etc.) to obtain received symbols. A MIMO detector 356 may obtain received symbols from all the demodulators 354a through 354r, perform MIMO detection on the received symbols if applicable, and provide detected symbols. A receive processor 358 may process (e.g., demodulate, deinterleave, and decode) the detected symbols, provide decoded data for the UE 120 to a data sink 360, and provide decoded control information to a controller/processor 380.

On the uplink, at the UE 120, a transmit processor 364 may receive and process data (e.g., for the PUSCH) from a data source 362 and control information (e.g., for the PUCCH) from the controller/processor 380. The transmit processor 364 may also generate reference symbols for a reference signal. The symbols from the transmit processor 364 may be precoded by a TX MIMO processor 366 if applicable, further processed by the demodulators 354a through 354r (e.g., for SC-FDM, etc.), and transmitted to the base station 110. At the base station 110, the uplink signals from the UE 120 may be received by the antennas 334, processed by the modulators 332, detected by a MIMO detector 336 if applicable, and further processed by a receive processor 338 to obtain decoded data and control information sent by the UE 120. The receive processor 338 may provide the decoded data to a data sink 339 and the decoded control information to the controller/processor 340.

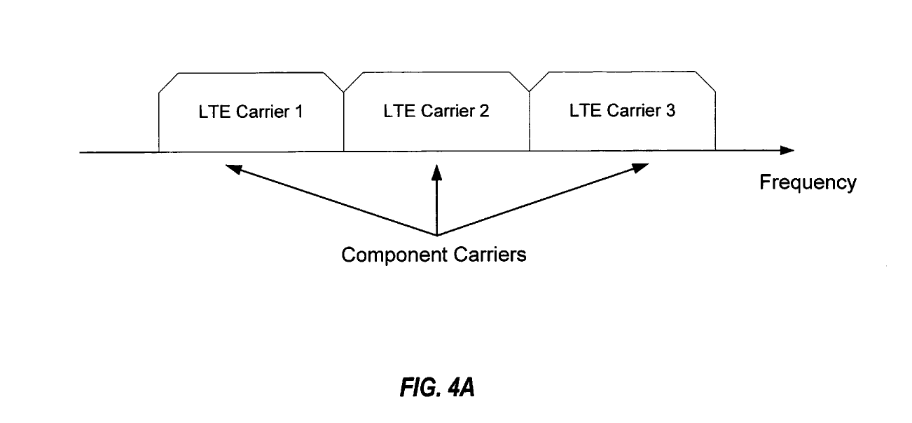

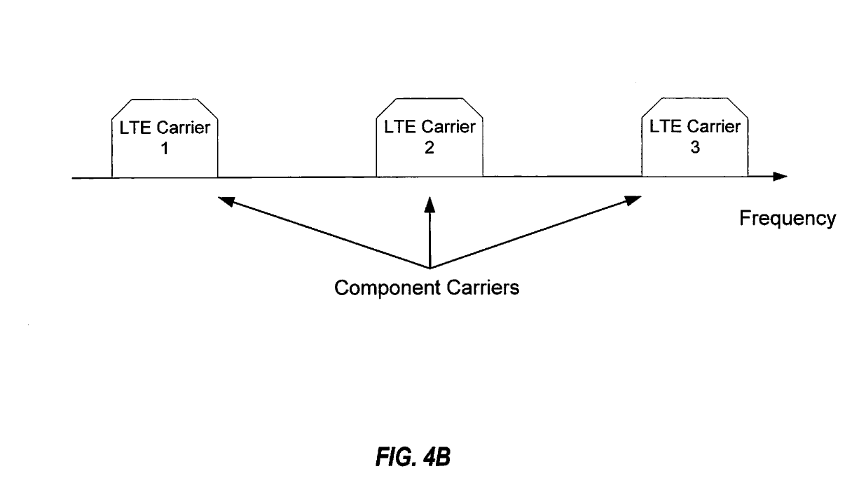

The controllers/processors 340 and 380 may direct the operation at the base station 110 and the UE 120, respectively. The processor 340 and/or other processors and modules at the base station 110 may perform or direct the execution of various processes for the techniques described herein. The processor 380 and/or other processors and modules at the UE 120 may also perform or direct the execution of the functional blocks illustrated in FIGS. 4A, 4B, 5 and 6, and/or other processes for the techniques described herein. The memories 342 and 382 may store data and program codes for the base station 110 and the UE 120, respectively. A scheduler 344 may schedule UEs for data transmission on the downlink and/or uplink.

In one configuration, the UE 120 for wireless communication includes means for detecting interference from an interfering base station during a connection mode of the UE, means for selecting a yielded resource of the interfering base station, means for obtaining an error rate of a physical downlink control channel on the yielded resource, and means, executable in response to the error rate exceeding a predetermined level, for declaring a radio link failure. In one aspect, the aforementioned means may be the processor(s), the controller/processor 380, the memory 382, the receive processor 358, the MIMO detector 356, the demodulators 354a, and the antennas 352a configured to perform the functions recited by the aforementioned means. In another aspect, the aforementioned means may be a module or any apparatus configured to perform the functions recited by the aforementioned means.

### Carrier Aggregation

LTE-Advanced UEs use spectrum up to 20 Mhz bandwidths allocated in a carrier aggregation of up to a total of 100 Mhz (5 component carriers) used for transmission in each direction. One component carrier is usually designated as the primary component carrier, which will typically carry any PUCCH and common search space signals. In LTE Release 10 (Rel-10), component carriers may be either all frequency division duplex (FDD) or time division duplex (TDD) without any mixing within the component carrier. Moreover, TDD component carriers generally have the same uplink and downlink configurations, although special subframes may be configured separately for different component carriers. In LTE Release 11 (Rel-11) and beyond, more flexibility has been suggested, such as through aggregation of TDD and FDD component carriers or TDD component carriers that may have different uplink and downlink configurations.

Generally, less traffic is transmitted on the uplink than the downlink, so the uplink spectrum allocation may be smaller than the downlink allocation. For example, if 20 Mhz is assigned to the uplink, the downlink may be assigned 100 Mhz. These asymmetric FDD assignments will conserve spectrum and are a good fit for the typically asymmetric bandwidth utilization by broadband subscribers.

Carrier aggregation also provides for use of SRS transmissions. In general, carrier aggregation supports parallel SRS transmission in which two or more component carriers may transmit SRS simultaneously. However, a UE does not typically transmit SRS in the same subframe/symbol as PUCCH or PUSCH. When PUCCH/PUSCH is scheduled in the same subframe/symbol as an SRS transmission, it is referred to as a collision, and the SRS will be canceled when such a collision occurs. In some circumstances, PUCCH and PUSCH may be transmitted in the same subframe if the shortened PUCCH/PUSCH format is used. SRS is transmitted in the last symbol of the subframe. The shortened format of PUCCH/PUSCH occupy fewer than all fourteen symbols in a subframe. When configured not to interfere with SRS transmissions, shortened form PUCCH/PUSCH may be transmitted in the same subframe as an SRS transmission.

### Carrier Aggregation Types

For the LTE-Advanced mobile systems, two types of carrier aggregation (CA) methods have been proposed, continuous CA and non-continuous CA. They are illustrated in FIGS. 4A and 4B. Non-continuous CA occurs when multiple available component carriers are separated along the frequency band (FIG. 4B). On the other hand, continuous CA occurs when multiple available component carriers are adjacent to each other (FIG. 4A). Both non-continuous and continuous CA aggregate multiple LTE/component carriers to serve a single unit of LTE Advanced UE.

Multiple RF receiving units and multiple FFTs may be deployed with non-continuous CA in LTE-Advanced UE since the carriers are separated along the frequency band. Because non-continuous CA supports data transmissions over multiple separated carriers across a large frequency range, propagation path loss, Doppler shift and other radio channel characteristics may vary considerably at different frequency bands.

Thus, to support broadband data transmission under the non-continuous CA approach, methods may be used to adaptively adjust coding, modulation and transmission power for different component carriers. For example, in an LTE-Advanced system where the enhanced NodeB (eNodeB) has fixed transmitting power on each component carrier, the effective coverage or supportable modulation and coding of each component carrier may be different.

### Data Aggregation Schemes

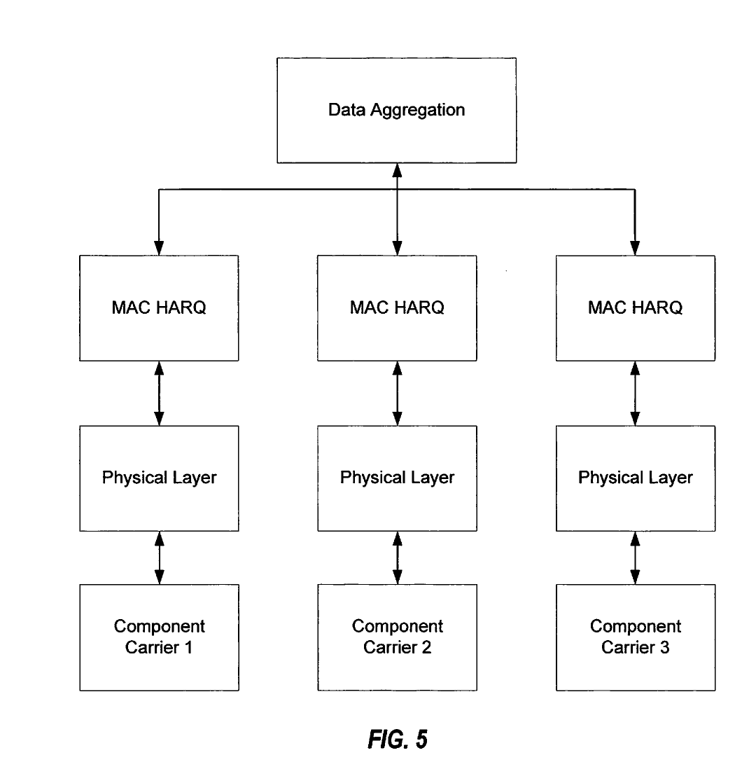

FIG. 5 illustrates aggregating transmission blocks (TBs) from different component carriers at the medium access control (MAC) layer (FIG. 5) for an IMT-Advanced system. With MAC layer data aggregation, each component carrier has its own independent hybrid automatic repeat request (HARQ) entity in the MAC layer and its own transmission configuration parameters (e.g., transmitting power, modulation and coding schemes, and multiple antenna configuration) in the physical layer. Similarly, in the physical layer, one HARQ entity is provided for each component carrier.

### Control Signaling

In general, there are three different approaches for deploying control channel signaling for multiple component carriers. The first involves a minor modification of the control structure in LTE systems where each component carrier is given its own coded control channel.

The second method involves jointly coding the control channels of different component carriers and deploying the control channels in a dedicated component carrier. The control information for the multiple component carriers will be integrated as the signaling content in this dedicated control channel. As a result, backward compatibility with the control channel structure in LTE systems is maintained, while signaling overhead in the CA is reduced.

Multiple control channels for different component carriers are jointly coded and then transmitted over the entire frequency band formed by a third CA method. This approach offers low signaling overhead and high decoding performance in control channels, at the expense of high power consumption at the UE side. However, this method is not compatible with LTE systems.

### Handover Control

It is preferable to support transmission continuity during the handover procedure across multiple cells when CA is used for IMT-Advanced UE. However, reserving sufficient system resources (i.e., component carriers with good transmission quality) for the incoming UE with specific CA configurations and quality of service (QoS) requirements may be challenging for the next eNodeB. The reason is that the channel conditions of two (or more) adjacent cells (eNodeBs) may be different for the specific UE. In one approach, the UE measures the performance of only one component carrier in each adjacent cell. This offers similar measurement delay, complexity, and energy consumption as that in LTE systems. An estimate of the performance of the other component carriers in the corresponding cell may be based on the measurement result of the one component carrier. Based on this estimate, the handover decision and transmission configuration may be determined.

According to various embodiments, the UE operating in a multicarrier system (also referred to as carrier aggregation) is configured to aggregate certain functions of multiple carriers, such as control and feedback functions, on the same carrier, which may be referred to as a “primary carrier.” The remaining carriers that depend on the primary carrier for support are referred to as associated secondary carriers. For example, the UE may aggregate control functions such as those provided by the optional dedicated channel (DCH), the nonscheduled grants, a physical uplink control channel (PUCCH), and/or a physical downlink control channel (PDCCH). Signaling and payload may be transmitted both on the downlink by the eNode B to the UE, and on the uplink by the UE to the eNode B.

In some embodiments, there may be multiple primary carriers. In addition, secondary carriers may be added or removed without affecting the basic operation of the UE, including physical channel establishment and RLF procedures which are layer 2 procedures, such as in the 3GPP technical specification 36.331 for the LTE RRC protocol.

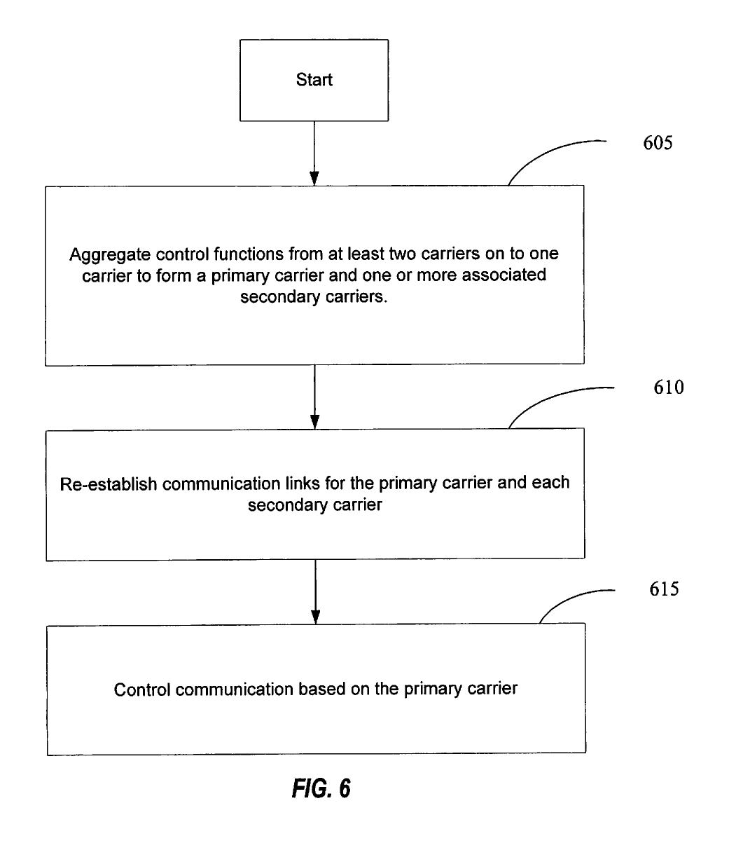

FIG. 6 illustrates a method 600 for controlling radio links in a multiple carrier wireless communication system by grouping physical channels according to one example. As shown, the method includes, at block 605, aggregating control functions from at least two carriers onto one carrier to form a primary carrier and one or more associated secondary carriers. Next at block, 610, communication links are established for the primary carrier and each secondary carrier. Then, communication is controlled based on the primary carrier in block 615.

It should be noted that the communication link with the primary carrier may have already been established before block 605. Accordingly, in some scenarios, there may be no need to re-establish the communication link for the primary carrier, and only communication links with each secondary carrier are established.

### Asymmetric Carrier Aggregation

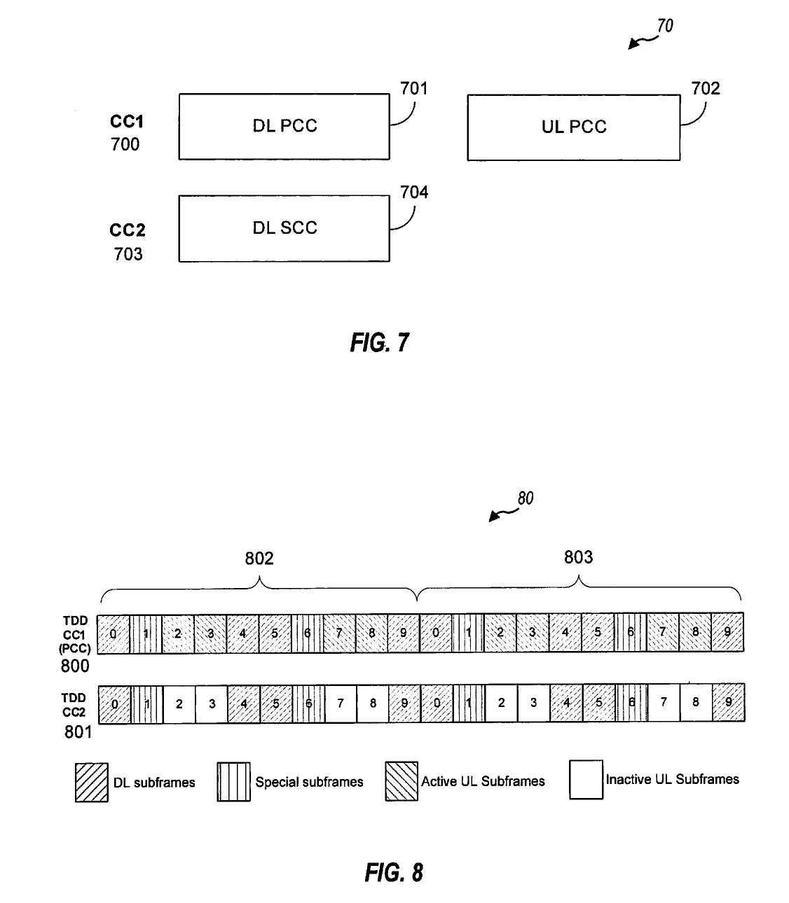

Some UEs may be configured with asymmetric CA in which there are multiple downlink component carriers, but only a single uplink component carrier or less number of uplink component carriers. FIG. 7 is a block diagram illustrating carrier aggregation 70 configured asymmetrically in a frequency division duplex (FDD) implementation. Component carrier 1 (CC 1) 700 includes downlink primary component carrier (PCC) 701 and uplink PCC 702, while component carrier 2 (CC2) 703 includes downlink secondary component carrier (SCC) 704. In CC1 700, downlink PCC 701 and uplink PCC 702 are paired component carriers. CC2 703 only includes downlink SCC 704 and is, therefore, non-paired. Because CC2 703 includes only non-paired downlink SCC 704, carrier aggregation 70 is considered to be asymmetric.

FIG. 8 is a block diagram illustrating carrier aggregation 80 configured asymmetrically in a time division duplex (TDD) implementation. The transmission stream of FIG. 8 shows two radio frames, radio frames 802 and 803, of a PCC 800 and SCC 801. PCC 800 is time division duplexed across its subframes to include downlink subframes, uplink subframes, and special subframes SCC 801 is time division duplexed across its subframes to include downlink subframes, inactive uplink subframes, and special subframes. Because the uplink subframes 2-3 and 7-8 of SCC 801 are inactive, the downlink subframes, subframes 0, 4-5, and 9, of SCC 801 are non-paired, and carrier aggregation 80 is also considered to be asymmetric.

For the non-paired downlink component carriers in asymmetric carrier aggregations, there is no SRS transmission. However, SRS transmissions could still be useful for operation in various alternative cases. For example, in TDD implementations, channel reciprocity is an important component and SRS is useful for downlink operations. For situations in which uplink and downlink PCC are decoupled, SRS for the non-paired downlink component carrier may be useful for uplink PCC reconfiguration and improved uplink PCC management. When an uplink component carrier is deactivated, but the downlink component carrier is not, SRS may be useful for the uplink component carrier to facilitate activation/deactivation management. Additionally, SRS may be useful for management of coordinated multipoint (CoMP) systems. In such CoMP systems, SRS is frequently used to determine the cells involved in PDSCH transmissions, power control, PDSCH/PUSCH/PUCCH cell management, interference management, and the like. In each of these circumstances, SRS would be useful, but, without an active uplink component carrier to be paired with the non-paired downlink component carriers, SRS may not be provided according to the usual mechanisms.

To provide SRS signaling to non-paired downlink component carriers, SRS are enabled for the non-paired component carriers while maintaining a single component carrier transmission at a time in order to prevent simultaneous transmissions over different component carriers. It is desirable to maintain a single carrier waveform for the single component carrier transmissions to keep lower transmission complexity. The SRS transmissions are time division multiplexed (TDM) over different component carriers. Furthermore, it is possible to enable non-single carrier waveform transmission over one or more component carriers, e.g., by allowing parallel UL transmissions over two or more component carriers, at the expense of additional complexity.

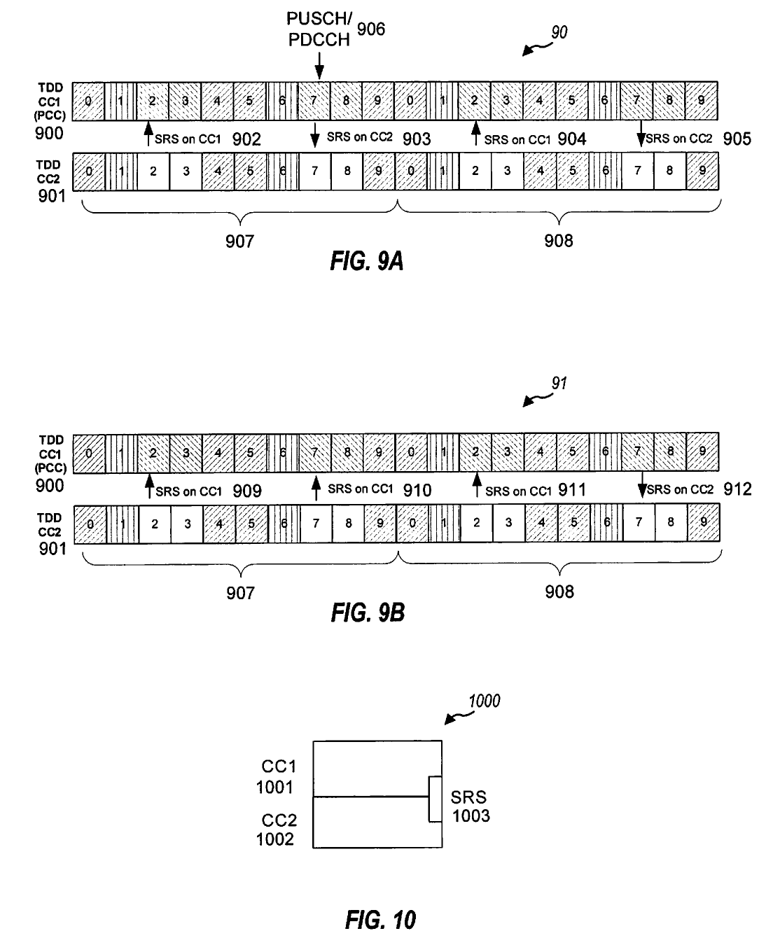

FIG. 9A is a block diagram illustrating carrier aggregation 90 with SRS signaling configured according to one aspect of the present disclosure. Carrier aggregation 90 includes TDD PCC 900 and TDD component carrier 901. The SRS transmissions are split between component carriers, TDD PCC 900 and TDD component carrier 901. For example, SRS 902 is transmitted at subframe 2 of radio frame 907 on TDD PCC 900, SRS 903 is transmitted at subframe 7 of radio frame 907 on TDD component carrier 901, SRS 904 is transmitted at subframe 2 of radio frame 908 on TDD PCC 900, and SRS 905 is transmitted at subframe 7 of radio frame 908 on TDD component carrier 901. In this manner, SRS 903 and 905 may be used to determine the channel quality for the non-paired downlink component carrier.

It should be noted that when collision events arise, prioritization among transmissions scheduled for the paired component carriers and scheduled for the non-paired component carriers can be performed. As an example, higher priority can be given to the transmissions scheduled for the paired component carriers. As another example, prioritization can be based on some characteristics of the physical channel in collision. For instance, among periodic SRS transmissions from different component carriers, the periodic SRS with the largest periodicity may be chosen to transmit while SRS of all other component carriers in collision are dropped. As yet another example, prioritization can be based on some RRC signaling (e.g., cell IDs of the component carriers). The prioritization can further consider various combinations of the above examples. Collision can be defined as two or more transmissions in the same subframe. Collision can also be defined as two or more transmissions in the same symbol. For the former, it implies that simultaneous transmissions over two or more component carriers are not allowed, even if the transmissions may happen over different symbols in the same subframe and within each symbol there is only one transmission in the same subframe. For the latter, it implies that it is possible to have two or more transmissions in the same subframe, as long as within each symbol there is only one transmission in the same subframe. For example, PUSCH/PDCCH 906 is scheduled for subframe 7 of radio frame 907. However, SRS 903 is also scheduled for transmission on the same subframe 7 of radio frame 907, but on TDD component carrier 901. If both transmissions were allowed to proceed, there would be simultaneous transmission from the UE on two separate component carriers. When such a collision event is encountered, the UE cancels the transmission of SRS 903 to maintain a single transmission at subframe 7 of radio frame 907, thus, avoiding dynamic switching of uplink component carrier transmissions within the same subframe.

The SRS transmissions may be split in any number of divisions between component carriers. The configuration and/or activation of SRS transmissions can be jointly or separately managed among component carriers. As an example, two separate configurations of SRS transmissions can be provided to a user equipment for two component carriers, where the two configurations may or may not have overlapped SRS transmission instances. The carrier aggregation 90 illustrates a uniform split among the component carriers. However, non-uniform divisions are contemplated in various alternative aspects. FIG. 9B is a block diagram illustrating carrier aggregation 91 with SRS signaling configured according to one aspect of the present disclosure. Carrier aggregation 91 illustrates two radio frames, radio frames 907 and 908, of component carriers TDD PCC 900 and TDD component carrier 901. SRS transmissions are scheduled in a non-uniform division that sounds more frequently on TDD PCC 900. SRS transmissions on TDD PCC 900 are made on subframes 2 and 7 of radio frame 907 and on subframe 2 of radio frame 908. TDD component carrier 901 is sounded with SRS transmission on subframe 7 of radio frame 908.

Depending on the configuration of the component carriers, there may be a special occurrence when two of the component carriers are contiguous in frequency. FIG. 10 is a block diagram illustrating one TDD subframe of carrier aggregation 1000 with SRS transmissions configured according to one aspect of the present disclosure. Component carrier 1 (CC1) 1001 and CC2 1002 are contiguous. For purposes of this disclosure, contiguous includes component carriers that are separated only by guard bands. In such a special subframe (e.g, in uplink pilot time slot (UpPTS) in special subframes of TDD transmissions), a single SRS transmission, SRS 1003, may span both CC1 1001 and CC2 1002 while keeping the single-carrier waveform. SRS 1003 can have the same maximum bandwidth as an SRS transmitted in a single component carrier subframe. Thus, no new bandwidth definitions need to be introduced into the present aspect.

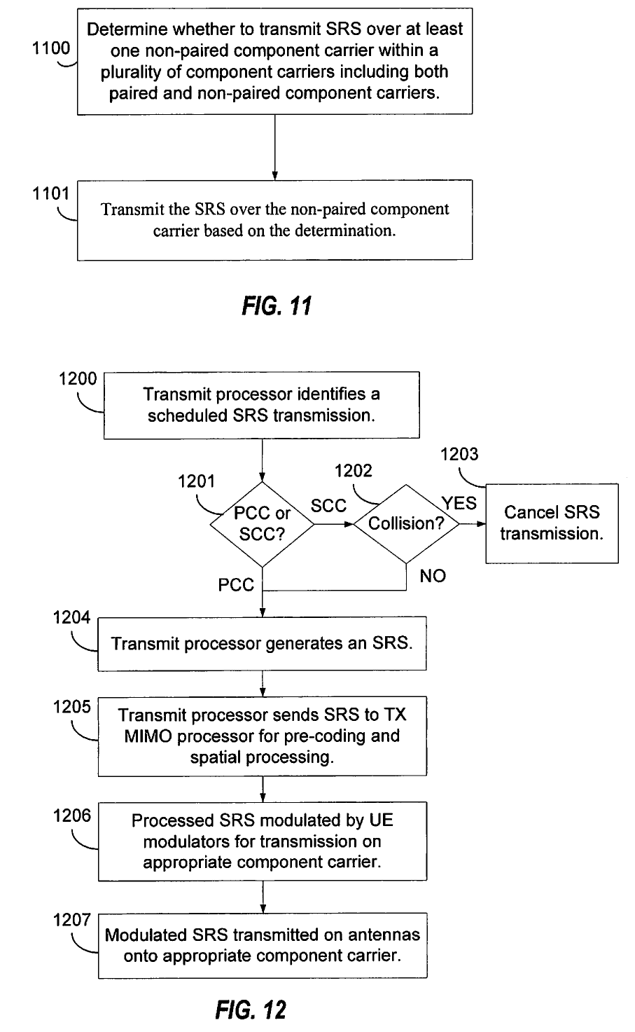

FIG. 11 is a functional block diagram illustrating example blocks executed to implement one aspect of the present disclosure. In block 1100, a determination is made whether to transmit SRS over at least one non-paired component carrier within multiple component carriers. The multiple component carriers include both paired component carriers and non-paired component carriers. The SRS are transmitted, in block 1101, over the non-paired component carrier based on the determination.

Referring back to FIG. 3, in one configuration, the UE 120 configured for wireless communication includes means for determining whether to transmit SRS over at least one non-paired component carrier within multiple component carriers including both paired and non-paired component carriers, and means for transmitting the SRS over the at least one non-paired component carrier based on the determination. In one aspect, the aforementioned means may be the processor(s), the controller/processor 380, the memory 382, the transmit processor 364, the TX MIMO processor 366, the modulators 354r, and the antennas 352a configured to perform the functions recited by the aforementioned means. In another aspect, the aforementioned means may be a module or any apparatus configured to perform the functions recited by the aforementioned means.

FIG. 12 is a functional block diagram illustrating example blocks executed by UE 120 to implement one aspect of the present disclosure. In block 1200, the transmit processor 364 identifies a scheduled time to transmit an SRS. The transmit processor 364 determines, in block 1201, whether the scheduled transmission is for a primary component carrier or a secondary component carrier. If the SRS is for transmission on a secondary component carrier, in block 1202, the transmit processor 364 identifies whether a simultaneous transmission is scheduled on the primary component carrier that creates a collision with the scheduled SRS. If a simultaneous transmission is scheduled on the primary component carrier, the transmit processor 364 cancels the identified SRS transmission in block 1203. If no simultaneous transmission is scheduled, then, in block 1204, the transmit processor 364 generates the SRS for transmission. If, in response to the determination in block 1201, the transmit processor 364 determines that the SRS is scheduled for transmission on the primary component carrier, the transmit processor 364 generates the SRS in block 1204. In block 1205, the transmit processor 364 sends the SRS to the TX MIMO processor 366 for pre-coding and spatial processing. The transmit processor 364 also passes a control signal which identifies the appropriate frequency for the SRS to be transmitted on in order to provide the SRS signal on the identified appropriate component carrier. Using the control signal from the transmit processor 364, the modulators 354a-r modulate the processed SRS signal, in block 1206, for transmission to the appropriate component carrier through antennas 352a-r in block 1207.

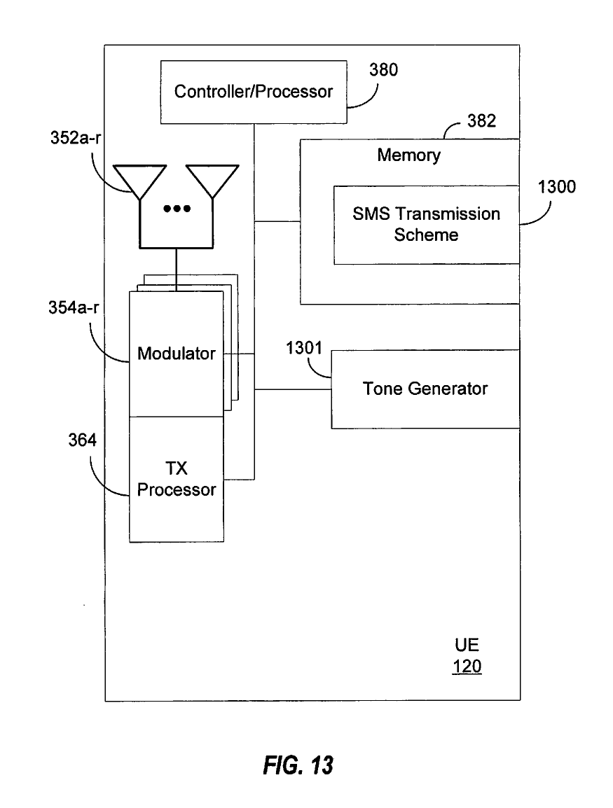

FIG. 13 is a block diagram illustrating a UE 120 configured according to one aspect of the present disclosure. UE 120 includes controller/processor 380 that controls the various components and executes any software or firmware that is used to operate the functionality and features of UE 120. An SRS transmission scheme 1300 is stored in memory 382. When executed by controller/processor 380, the SRS transmission scheme 1300 provides for making a determination of whether to transmit SRS over a non-paired component carrier. The combination of these components provides means for determining whether to transmit SRS over at least one non-paired component carrier within multiple component carriers including both paired and non-paired component carriers.

The SRS transmission scheme 1300, under control of controller/processor 380, provides for directing the generation of SRS, using tone generator 1301. The executing SRS transmission scheme 1300, under control of the controller/processor 380, further triggers tone generator 1301 to generate such SRS. The controller/processor 380, executing the SRS transmission scheme 1300, controls the transmit processor 364 and modulators 354a-r to transmit the generated SRS over antennas 352a-4. The combination of these components provide means for transmitting the SRS over different ones of the paired component carriers and the at least one non-paired component carrier, wherein each transmitted SRS is transmitted in a different subframe. The SRS transmission scheme 1300 includes information with regard to the paired and non-paired component carriers, such that the transmit processor 364 and modulators 354a-r may properly modulate and transmit the generated SRS.

It should be noted that various control signals may be implemented for controlling features of the SRS transmission implementation of the various aspects of the present disclosure. For example, power control for SRS on non-paired component carriers may be provided for in both open loop or closed loop means. Open loop power control maybe implemented for the non-paired component carriers using RRC configuration. Closed loop power control may be provided for the non-paired component carriers through a downlink control information (DCI) message in format 3/3A. Such DCI messages may be sent either for the non-paired downlink component carrier or from the primary component carrier via a cross-carrier power control. Closed loop power control may also be provided for the non-paired component carriers with UE-specific power control via an uplink grant for the non-paired downlink component carrier.

Time adjustments may also be provided for SRS transmission on the non-paired component carriers. A time-adjustment (TA) command may be transmitted over the non-paired downlink component carriers or paired downlink component carriers (using a cross-carrier TA command) to manage the SRS transmission timing for the UE. Where group signaling is used, in which a single TA command is shared by all or a group of component carriers that include the non-paired component carriers, the no separate TA command would be required.

It should be noted that for FDD-type non-paired component carriers, the switching time between transmissions over two component carriers can be relatively long. As an example, the switching time can be on the order of 300 μs or roughly half of a subframe. As a result, one or two uplink subframe(s) may be lost due to switching. The impact of this loss may not be significant for the FDD-type since the transmission of SRS on the non-paired component carriers is generally infrequent. For TDD-type non-paired component carriers, the switching time is relatively short since the UE already operates on both the non-paired component carriers and the paired component carriers. As a result, the impact is less when compared with the FDD case. Such an impact may be handled by implementation changes or through modification of the standards specification. As an example, SRS for non-paired component carriers may be restricted for transmission only during the uplink pilot time slot (UpPTS), especially in the first symbol of the two UpPTS symbols, if so configured, in order to better absorb the impact of switching time.

It should further be noted that the various aspects of the present disclosure may be applicable to either periodic SRS or aperiodic SRS. In periodic SRS, switching of component carriers may be triggered similarly to uplink antenna switching. Such switching would be based on an SRS counter, where the index of the appropriate component carrier may be derived based on the division of transmission being employed (e.g., uniform or non-uniform). In aperiodic SRS, component carrier switching may be triggered through DCI messages in both uplink or downlink grants. Cross-component carrier SRS triggering may also be enabled for all or some of the DCI formats. Furthermore, rules may be implemented that create a default SRS trigger for any downlink grant DCI messages from the non-paired downlink component carriers. Additional means for triggering in either periodic or aperiodic SRS may also be used. The present disclosure is not limited to any specific triggering mechanism.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill would further appreciate that the various illustrative logical blocks, modules, circuits, and algorithm steps described in connection with the disclosure herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the disclosure herein may be implemented or performed with a general-purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the disclosure herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

In one or more exemplary designs, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein but is to be accorded the widest scope consistent with the principles and novel features disclosed herein.

What is claimed is:

1. A method of wireless communication, comprising:
determining whether to transmit a sounding reference signal (SRS) over at least one non-paired component carrier within a plurality of component carriers, the plurality of component carriers including at least one paired component carrier and the at least one non-paired component carrier; and
transmitting the SRS over the at least one non-paired component carrier based on the determination.

2. The method of claim 1, wherein the determining is based at least in part on a radio resource control (RRC) configuration.

3. The method of claim 1, wherein the determining is based at least in part on an indication in a control channel.

4. The method of claim 3, wherein the control channel schedules one of the downlink and uplink grants.

5. The method of claim 1, further including:
determining to perform uplink transmission over the at least one paired component carrier in a first subframe; and
dropping transmission of the SRS over the at least one non-paired component carrier in the first subframe in response to the determining to perform uplink transmission.

6. The method of claim 5, wherein the uplink transmission over the at least one paired component carrier includes one of:
a physical uplink control channel (PUCCH);
a physical uplink shared channel (PUSCH); and
the SRS.

7. The method of claim 1, further including:
transmitting the SRS over the at least one paired component carrier, wherein the SRS transmitted over the at least one paired component carrier is transmitted in a different subframe than the SRS transmitted over the at least one non-paired component carrier.

8. The method of claim 1, wherein the SRS is transmitted more frequently over the at least one paired component carrier than over the at least one non-paired component carrier.

9. The method of claim 1, further including:
canceling transmission of the SRS on one of the at least one non-paired component carrier when a transmission is performed on the paired component carrier in a previous subframe adjacent to a subframe of the canceled transmission.

10. The method of claim 1, wherein at least two component carriers of the plurality of component carriers are contiguous in frequency, and wherein the transmitting the SRS over the at least one non-paired component carrier includes:
transmitting a single SRS spanning a portion of the at least one paired component carrier.

11. The method of claim 1, wherein the SRS transmission is one of:
an aperiodic SRS; and
a periodic SRS.

12. The method of claim 1, wherein the at least one non-paired carrier is one of:
a frequency division duplex (FDD) carrier; and
a time division duplex (TDD) carrier.

13. An apparatus of wireless communication, comprising:
means for determining whether to transmit a sounding reference signal (SRS) over at least one non-paired component carrier within a plurality of component carriers, the plurality of component carriers including at least one paired component carrier and the at least one non-paired component carrier; and
means for transmitting the SRS over the at least one non-paired component carrier based on the determination.

14. The apparatus of claim 13, wherein the means for determining is based at least in part on a radio resource control (RRC) configuration.

15. The apparatus of claim 13, wherein the means for determining is based at least in part on an indication in a control channel.

16. The apparatus of claim 15, wherein the control channel schedules one of the downlink and uplink grants.

17. The apparatus of claim 13, further including:
means for determining to perform uplink transmission over the at least one paired component carrier in a first subframe; and
means for dropping transmission of the SRS over the at least one non-paired component carrier in the first subframe in response to the determining to perform uplink transmission.

18. The apparatus of claim 17, wherein the uplink transmission over the at least one paired component carrier includes one of:
a physical uplink control channel (PUCCH);
a physical uplink shared channel (PUSCH); and
the SRS.

19. The apparatus of claim 13, further including:
means for transmitting the SRS over the at least one paired component carrier, wherein the SRS transmitted over the at least one paired component carrier is transmitted in a different subframe than the SRS transmitted over the at least one non-paired component carrier.

20. The apparatus of claim 13, wherein the SRS is transmitted more frequently over the at least one paired component carrier than over the at least one non-paired component carrier.

21. The apparatus of claim 13, further including:
means for canceling transmission of the SRS on one of the at least one non-paired component carrier when a transmission is performed on the paired component carrier in a previous subframe adjacent to a subframe of the canceled transmission.

22. The apparatus of claim 13, wherein at least two component carriers of the plurality of component carriers are contiguous in frequency, and wherein the means for transmitting the SRS over the at least one non-paired component carrier includes:
means for transmitting a single SRS spanning a portion of the at least one paired component carrier.

23. The apparatus of claim 13, wherein the SRS transmission is one of:
an aperiodic SRS; and
a periodic SRS.

24. The apparatus of claim 13, wherein the at least one non-paired carrier is one of:
a frequency division duplex (FDD) carrier; and
a time division duplex (TDD) carrier.

25. A computer program product for wireless communications in a wireless network, comprising:
a computer-readable storage medium having program code stored thereon, the program code including:
program code to determine whether to transmit a sounding reference signal (SRS) over at least one non-paired component carrier within a plurality of component carriers, the plurality of component carriers including at least one paired component carrier and the at least one non-paired component carrier; and
program code to transmit the SRS over the at least one non-paired component carrier based on the determination.

26. The computer program product of claim 25, wherein the program code to determine is based at least in part on a radio resource control (RRC) configuration.

27. The computer program product of claim 25, wherein the program code to determine is based at least in part on an indication in a control channel.

28. The computer program product of claim 27, wherein the control channel schedules one of the downlink and uplink grants.

29. The computer program product of claim 25, further including:
program code to determine to perform uplink transmission over the at least one paired component carrier in a first subframe; and
program code to drop transmission of the SRS over the at least one non-paired component carrier in the first subframe in response to the determining to perform uplink transmission.

30. The computer program product of claim 29, wherein the uplink transmission over the at least one paired component carrier includes one of:
a physical uplink control channel (PUCCH);
a physical uplink shared channel (PUSCH); and
the SRS.

31. The computer program product of claim 25, further including:
program code to transmit the SRS over the at least one paired component carrier, wherein the SRS transmitted over the at least one paired component carrier is transmitted in a different subframe than the SRS transmitted over the at least one non-paired component carrier.

32. The computer program product of claim 25, wherein the SRS is transmitted more frequently over the at least one paired component carrier than over the at least one non-paired component carrier.

33. The computer program product of claim 25, further including:
program code to cancel transmission of the SRS on one of the at least one non-paired component carrier when a transmission is performed on the paired component carrier in a previous subframe adjacent to a subframe of the canceled transmission.

34. The computer program product of claim 25, wherein at least two component carriers of the plurality of component carriers are contiguous in frequency, and wherein the program code to transmit the SRS over the at least one non-paired component carrier includes:
program code to transmit a single SRS spanning a portion of the at least one paired component carrier.

35. The computer program product of claim 25, wherein the SRS transmission is one of:
an aperiodic SRS; and
a periodic SRS.

36. The computer program product of claim 25, wherein the at least one non-paired carrier is one of:
a frequency division duplex (FDD) carrier; and
a time division duplex (TDD) carrier.

37. An apparatus configured for wireless communication, the apparatus comprising:
at least one processor; and
a memory coupled to the at least one processor, wherein the at least one processor is configured:
to determine whether to transmit a sounding reference signal (SRS) over at least one non-paired component carrier within a plurality of component carriers, the plurality of component carriers including at least one paired component carrier and the at least one non-paired component carrier; and
to transmit the SRS over the at least one non-paired component carrier based on the determination.

38. The apparatus of claim 37, wherein the configuration of the at least one processor to determine is based at least in part on a radio resource control (RRC) configuration.

39. The apparatus of claim 37, wherein the configuration of the at least one processor to determine is based at least in part on an indication in a control channel.

40. The apparatus of claim 39, wherein the control channel schedules one of the downlink and uplink grants.

41. The apparatus of claim 37, wherein the at least one processor is further configured:
to determine to perform uplink transmission over the at least one paired component carrier in a first subframe; and
to drop transmission of the SRS over the at least one non-paired component carrier in the first subframe in response to the determining to perform uplink transmission.

42. The apparatus of claim 41, wherein the uplink transmission over the at least one paired component carrier includes one of:
a physical uplink control channel (PUCCH);
a physical uplink shared channel (PUSCH); and
the SRS.

43. The apparatus of claim 37, wherein the at least one processor is further configured:
to transmit the SRS over the at least one paired component carrier, wherein the SRS transmitted over the at least one paired component carrier is transmitted in a different subframe than the SRS transmitted over the at least one non-paired component carrier.

44. The apparatus of claim 37, wherein the SRS is transmitted more frequently over the at least one paired component carrier than over the at least one non-paired component carrier.

45. The apparatus of claim 37, wherein the at least one processor is further configured:
to cancel transmission of the SRS on one of the at least one non-paired component carrier when a transmission is performed on the paired component carrier in a previous subframe adjacent to a subframe of the canceled transmission.

46. The apparatus of claim 37, wherein at least two component carriers of the plurality of component carriers are contiguous in frequency, and wherein the configuration of the at least on processor to transmit the SRS over the at least one non-paired component carrier includes configuration to transmit a single SRS spanning a portion of the at least one paired component carrier.

47. The apparatus of claim 37, wherein the SRS transmission is one of:
an aperiodic SRS; and
a periodic SRS.

48. The apparatus of claim 37, wherein the at least one non-paired carrier is one of:
a frequency division duplex (FDD) carrier; and
a time division duplex (TDD) carrier.
